(19) United States
(12) Patent Application Publication
(10) Pub. No.: US 2012/0075229 A1
(43) Pub. Date: Mar. 29, 2012

(54) TOUCH SCREEN, RELATED METHOD OF OPERATION AND SYSTEM

(75) Inventor: Ian Summers, Berkshire (GB)

(73) Assignee: NEC CORPORATION, Tokyo (JP)

(21) Appl. No.: 13/320,927

(22) PCT Filed: May 14, 2010
(86) PCT No.: PCT/JP2010/058680

§ 371 Date: Dec. 12, 2011

(30) Foreign Application Priority Data
May 18, 2009 (GB) 0908456.7

(51) Int. Cl. G06F 3/041

(52) U.S. Cl. 345/173

(57) ABSTRACT

An exemplary embodiment concerns a touch screen arranged to determine when touched by a user's screen-engagement member and further arranged to identify an identifying characteristic of the engagement member and so as to differentiate between different screen-engagement members and wherein at least one aspect of subsequent operation of the screen is responsive to the identification of the member.

### TECHNICAL FIELD

The present invention relates to touch screens which can commonly form an interface device for mobile, hand held, electronic devices and also generally larger scale work stations and control systems.

### BACKGROUND ART

Touch screens are generally considered advantageous as interface devices insofar as they allow a user to interact directly with the element of the device/system displaying information relevant to the operation of that device/system.

Also, the incorporation of such known touch screens can also help remove the need for a separate user-interface device such as a standard keyboard thereby making the device more compact and, readily portable.

### CITATION LIST

### Patent Literature

PTL 1: US Patent Publication No. 2005/193351

PTL 2: International Patent Publication No. WO 2009/032638

PTL 3: US Patent Publication No. 2006/274044

PTL 4: US Patent Publication No. 2009/037846

### SUMMARY OF INVENTION

### Technical Problem

However, while offering advantages over standard keyboards, current touch screens nevertheless exhibit disadvantages and limitations in that to allow for appropriate use, control and navigation functionality, an excessive number of “touches” are often required by the user which serves to limit the speed within which the device/apparatus/system can be employed and can be seen to make use of the screen seemingly unnecessarily complex and inefficient.

With such a relatively high level of end-user interaction, a disadvantageously high number of changes are required to the user interface rendering and this can disadvantageously consume CPU resources and also require more power for the device/apparatus/system. Limited control is also exhibited by known touch screens insofar as it does not prove possible to allow for ready use within a multi-user environment requiring different user settings and privileges. Potential security weaknesses therefore arise when adopting touch screens as currently known in the art.

Examples of such known touch screens can be found in, for example, the above patent literatures, i.e. US-A-2005/193351, WO-A-2009/032638, US-A-2006/274044 and US-A-2009/037846.

While all of these earlier documents focus upon user interfaces generally employing touch screens, none seek to address the disadvantages noted above such that the limitations mentioned still remain.

### Solution to Problem

An exemplary object of the present invention is to provide for a touch screen, method of operation and related system having advantages over known such screens, methods and systems.

According to an exemplary aspect of the invention there is provided a touch screen arranged to determine when touched by a user's screen-engagement member and further arranged to identify an identifying characteristic of the said engagement member and so as to differentiate between different screen-engagement members and wherein at least one aspect of subsequent operation of the screen is responsive to the identification of the said member.

According to an exemplary aspect of the invention there is provided a method of controlling at least one aspect of operation of a touch screen including determining when touched by a user's screen engagement member and including the steps of identifying an identifying characteristic of the said screen engagement member so as to differentiate between different screen engagement members, and wherein the said at least one aspect is controlled responsive to identification of the said screen engagement member.

### Advantageous Effects of Invention

A touch screen, method of operation and related system having advantages over known such screens, methods and systems have been provided.

### BRIEF DESCRIPTION OF DRAWINGS

[FIG. 1]

FIG. 1 is a schematic representation of a section through part of a touch screen embodying the present embodiment.

[FIG. 2]

FIG. 2 is a schematic plan view showing a user's engagement with a touch screen embodying the present embodiment.

[FIG. 3]

FIG. 3 is a further plan view showing operation of a touch screen embodying the present embodiment.

[FIG. 4]

FIG. 4 is yet a further plan view of the touch screen embodying the present embodiment during use.

[FIG. 5]

FIG. 5 is still a further plan view of such a touch screen embodying the present embodiment.

[FIG. 6]

FIG. 6 illustrates a high-level mapping table illustrating an example of preconfigured use of screen embodying the present embodiment.

[FIG. 7]

FIG. 7 is a flow chart illustrating use of touch screen apparatus embodying the present embodiment.

### DESCRIPTION OF EMBODIMENTS

According to a first aspect of the present embodiment there is provided a touch screen arranged to determine when touched by a user's screen-engagement member, and further arranged to identify an identifying characteristic of the said engagement member and so as to differentiate between different screen-engagement members, and wherein at least one aspect of subsequent operation of the screen is responsive to the identification of the said member.

The embodiment proves advantageous insofar as the identification of the screen-engagement member serves to differentiate between different simultaneous screen touches by different screen-engagement members and can further differentiate between screen touches by different screen users. Through such functionality it advantageously proves possible to render the operation of, and interaction with, the screen with far greater simplicity and efficiency than is currently possible and can readily serve to reduce the overall number of screen touches required to achieve a required degree of control and interaction. Greater simplicity and speed of operation can therefore be achieved.

The device can readily recognise concurrent multiple contacts and readily associate these with different contact members/users so as to initiate, if required, a predefined response.

For example, the screen device of the present embodiment can readily identify a specific end-user and also differentiate between that end-users screen-engagement members, such as their fingers and thumbs, and further, each such member, in making contact with the touch screen, can cause the screen and any related device/system to function in an appropriate manner.

As will be appreciated the touch screen can advantageously an interface device and can include part of an electronic device to which is interfacing, such as a portable device in the form of a PDA, mobile phone handset or laptop/notebook.

Further, the interface device can be arranged for interfacing with a separate device, apparatus or system.

In particular, the touch screen can include one of a plurality of interface devices for an electronic data management/control system. In particular, the touch screen can be arranged for use in a multiple-user device/system.

In one particular embodiment, the touch screen is arranged for interaction with a screen-engagement member comprising one or both of a user's finger and thumb.

The identifying characteristic can then advantageously include biometric data and, for example, can include a finger/thumb print.

Advantageously, the touch screen is arranged to employ capacitive sensors so as to employ a measure of capacitate as a means for determining the thumb/finger print of the user.

As an alternative, the screen-engagement member can include a screen contact device which further, can advantageously include an electronic identification device, such as an electronic tag, serving to provide the said identifying characteristics.

Such devices can advantageously be arranged to be worn upon the user's hand and/or finger.

As a further example, such a screen-engagement member can include a screen-engagement stylus.

As will be appreciated, the said identifying characteristic can be arranged to identify the screen-engagement member and/or, the actual end user of the device employing that member.

While the absolute operation of the screen may be controlled responsive to the identification of the screen-engagement member, as noted, is only required that at least one aspect of the subsequent operation be so controlled.

For example, at least one of the display options, function options, functional control options and screen device/apparatus/system access functions can be controlled responsive to the identification of the said screen-engagement member.

With regard to the display options, a portion of the screen can be arranged to display an image representative of a further interactive field. Such further interactive field can include at least one region for identifying characteristics of a screen-engagement member for differentiating between different screen-engagement members. Thus, once a specific display field has opened and as determined by the user initially engaging with the screen, a further level of control can be achieved through a separate level of user-differentiation through user engagement with the displayed region. The engagement within this region by different users can provide for further different subsequent actions/events responsive to the identity of the particular user engaging the screen at that time. Any such displayed region can therefore include a so-called trigger point with which a user engages in order to initiate such further required actions/events. Of course, one or more such trigger points can be provided within any such displayed field.

As will be appreciated from the above, such a generally cascading control arrangement advantageously can be employed by way of a menu-tree type structure.

Should the at least one aspect of the subsequent operation of the screen include control of access to the screen, or the device/apparatus/system of which the screen forms part, appropriate user settings and/or privileges can be controlled responsive to the identification of the said member. The touch screen's subsequent operation is then controlled accordingly.

According to another aspect of the present embodiment there is provided a multi-user electronic control system including at least one touch screen device as defined above.

According to yet another aspect of the present embodiment, there is provided a method of controlling at least one aspect of the operation of a touch screen including determining when the screen is touched by a user's screen engagement member, and including the step of identifying an identifying characteristic of the said screen-engagement member so as to differentiate between different screen engagement members and wherein the said at least one aspect is controlled responsive to the identification of the said screen engagement member.

It should therefore be appreciated that the present embodiment relates to the provision of a touch screen employing any appropriate sensor technology to uniquely identify one or more of the unique characteristics of, for example, biometric data on each of the end-users fingers and thumbs whilst touching the display screen whether as a single, or multiple contact point. In this manner, (biometric) data identifying an end user's finger or thumb such as their finger/thumb print, can be readily employed to identify which finger or thumb has made contact with the screen or indeed to identify which user is currently operating the screen. Predetermined, or user-selected operational functions can be controlled through use of the different fingers and thumbs. For example, when one user's finger is placed randomly on the screen, the screen and its related device can readily identify the particular user and for example then readily invoke a required function such as a “play” function of an MP3 application within the device. Of course, whereas the user's other fingers and thumb can invoke different functions such as “forward”, “rewind” or “pause” functions. Further, should a different user be identified as interacting with the screen, the fingers and thumbs of that user might invoke different actions as required.

The embodiment is particularly useful therefore in allowing for an improved degree of control through multi-contact of the screen and through multi-user interaction with the screen insofar as appropriate levels of relative user-settings, security access, and privileges can readily be invoked and controlled. Of course, it should also be appreciated that the present embodiment can include means for capturing the aforementioned identifying characteristic and storing the same along with, if required, the appropriate user-settings, level of access and privileges etc.

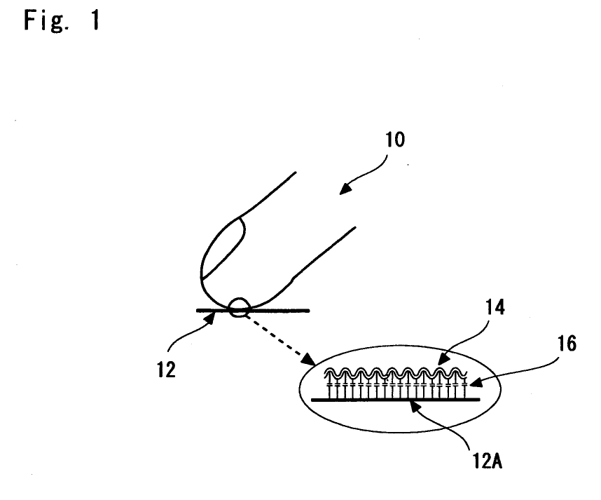

The embodiment is described further hereinafter, by way of example only, reference to the accompanying drawings FIGS. 1-7.

Turning first to FIG. 1 there is provided a schematic representation of part of a touch screen according to an embodiment of the present embodiment.

As will appreciated, the touch screen of the present embodiment can employ any appropriate sensor-array by means of which not only can the location of the user's touch on the screen be determined but, in accordance with the embodiment, further identifying data can be readily determined.

In the examples outlined below, a user's finger is generally employed as the screen-engagement member and the biometric data represented by the user's finger print serves to include the identifying characteristic of the finger.

As will be appreciated, in addition to the original resistive sensors, touch screens now operate in accordance with a wide variety of characteristics such as surface acoustic wave screens, capacitive screens, projective capacitive screens, infrared screens and others.

With regard to the present embodiment, a particularly appropriate form of touch screen is considered to include capacitive sensors and such as illustrated in FIG. 1. Here there is provided an indication of a user's finger 10 in engagement with the surface 12 of a touch screen wherein a portion of that point of contact is illustrated in enlarged view showing the contact portion 12A of the screen surface 12 and further illustrated with reference to, the under surface 14 of a user's finger comprising a series of peaks and troughs defined by the user's fingerprint.

A series of capacitive sensors 16 is effectively formed between the surface portion 12a and the under surface 14 of the user's finger as illustrated in FIG. 1.

Current CMOS capacitive sensors can serve to measure the capacitance between the sensor and the surface 14 of the user's finger to a high degree of resolution, such as in the order of 22 nm, or indeed to a dimension corresponding to that of an individual pixel. Such resolution allows an electronic device to measure and record the contours of the surface 14 of the user's finger 16 which therefore includes a representation of the user's fingerprint. As mentioned, the peaks and troughs of these contours represent different capacitive values.

Through the measurement of such capacitive values, it proves readily possible to represent the individual point of finger contact in three dimensions. The surface area provides the first and second dimensions (X and Y axis), whereas the value of the capacity represents features of the finger surface in a third dimension (Z axis).

Through to such readings in the x, y and z axis, it becomes readily possible to measure, record and subsequently identify a group of activated sensors to provide a unique rendering of an individual user's fingerprint.

Insofar as each of the user's fingers will offer a different fingerprint, quite separate readings can be achieved for each of the user's different eight fingers and two thumbs such that the screen can readily differentiate between similar points of contact occurring simultaneously between all of the user's fingers and thumbs.

Advantageously therefore, through determining representation of the user's fingerprint, a touch screen configured such as that of FIG. 1 can be arranged, if required, to first capture a three dimensional representation of the user's finger, including a finger print pattern and stored the same for ready use as required. Of course, such fingerprint data can be captured by other means and subsequently loaded on to the touch screen device as required.

In any case, during subsequent use of the embodiment, not only can the location of the point of contact be readily determined, but also the identity of which user is currently contacting and, if required, which of the ten possible digits is being used at the, or each, point of contact.

The touch screen can therefore advantageously track multiple simultaneous contacts of a single user leading to a particularly simple, yet time efficient interaction of the touch screen. Yet further, a particular layer of security relating to predefined user settings and allowed privileges, the actual identification of each particular user, can readily be achieved so as to configure the device in an appropriate manner for operation in accordance with such settings and privileges and of course to allow/deny ongoing access as required. As an example, if the end user is using a MP3 player function, control of the “play”, “pause”, “forward”, “reverse” and “stop” functions can be assigned to each of the user's fingers and thumb of, for example, their right hand such that the mere contact of either of those digits on the touch screen of the MP3 player can readily be identified so as to control operation of the screen.

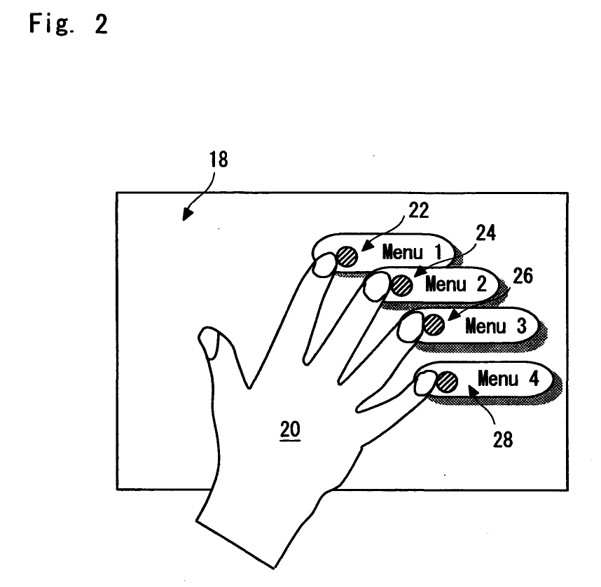

Reference is made for further illustration to FIG. 2 and which shows a plan view of a touch screen 18 according to an embodiment of the present embodiment and which has been touched by the four fingers of a user's right hand 20.

The touch screen has previously been preset to determine which of four possible menus 22-28 will open for appearance on the screen 18 responsive to identification of the finger prints of each of the user's four fingers as illustrated.

Thus, if required, the user can simply access one of the menus merely through contact with the screen 18 by way of the selected one of their fingers.

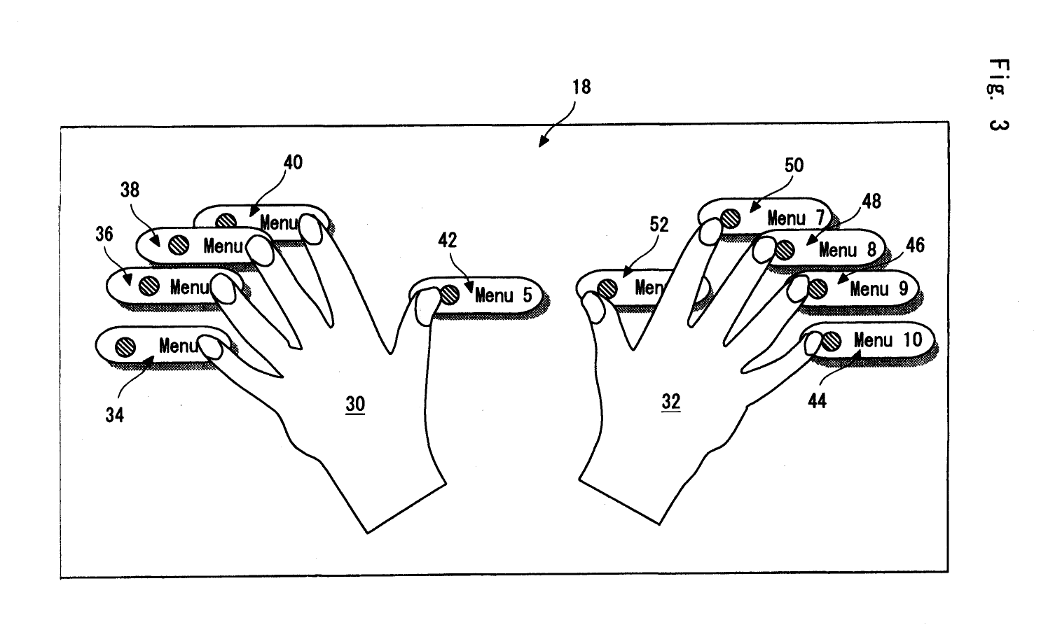

The ready identification of each of the user's different fingers/thumbs can also allow for interaction of the user with a screen and with their hands configured as if using a standard “qwerty” keyboard. Such illustration is provided in FIG. 3 in which two of a user's hand 30, 32 are illustrated in engagement with the screen 18 and wherein each of the users thumbs/fingers as arranged to be recognised by the touch screen 18 so as to open an appropriate one of ten possible menus.

That is, each of the fingers of the user's left hand 30 can be arranged to open menus 34-40, wherein the users left hand 30 thumb is arranged to open then view 42.

The user's right hand is arranged to open menus 44-50 through use of the relevant fingers, and menu 52 through use of the relevant thumb. A wide variety of options can therefore be readily presented by way of various menus and simply by the user engaging once with the touch screen 18; of course “once” here means a single but simultaneous contact between all of the fingers and thumbs and the screen 18.

It should also be appreciated that user engagement of screen 18 need not simply lead to the display of an appropriate selection of menus.

Any appropriate functionality, access control, or display option can be selectively determined in accordance with which of a user's other digits is in contact with the display screen 18. Once it has been determined which user is engaging with the screen, an appropriate control interface can be presented by way of a screen allowing for the appropriate level of contact over any device/apparatus/system interfacing with the screen.

Of course the screen 18 could form one of a plurality of screens arranged for operation within a multi-user environment. Indeed a multi-user environment can readily find use employing a single screen such as that 18 illustrated in the accompanying figures insofar as such a single screen can readily determine when the identity of a user changes and can quickly switch between appropriate use in accordance with different users extremely. It is a particular advantage of the present embodiment that it is one of the same contact operation that is required for functional use of the screen that is also employed as part of the user-identification process such that separate log-on/user-access introduction scenarios are not necessarily then required.

Further levels of selective functionality can be built into the screen and its related device/operation/system as required. For example, a displayed image of each of the menu options in FIGS. 2 and 3 illustrates a circular trigger point which can be employed within each menu image so as to initiate further control/selection functionality.

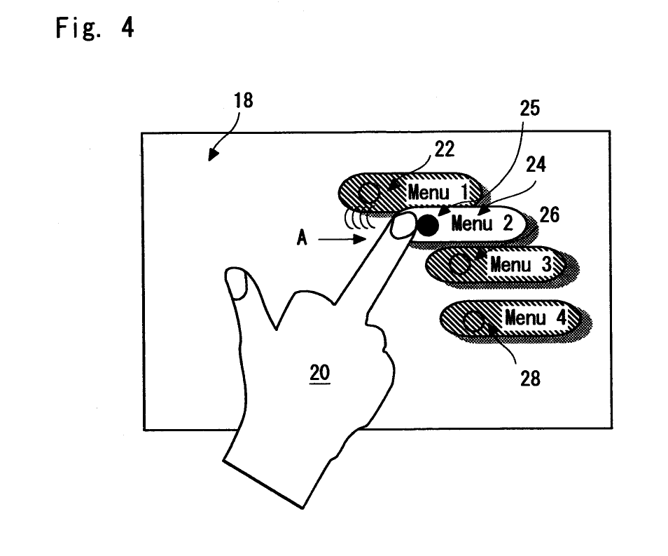

Reference is now made to FIG. 4 in which the user's right hand 20 of FIG. 2 and the various menu options 22-28 are also illustrated therein.

Within FIG. 4 however the user has decided that menu 24 is the most appropriate menu for subsequent use and selects the same by further engagement therewith and, in particular, movement of the relevant finger in the direction of arrow A in FIG. 4 across the trigger point 25. Through selection of the second menu 24, the other three menus 22, 26 and 28 can either be displayed at a reduced contrast, or can be arranged to disappear completely from the display 18.

Such trigger point 25 serves as a region within the image field representation of the menu 24 which itself is arranged to identify an identifying characteristic of the user so as to differentiate between the different users, or indeed different fingers/thumbs of a user. The identification of the user, or user's digit interacting with the trigger point 25 can readily serve to control which of a variety of further options is enabled. It should of course be appreciated that the trigger point 25 can be arranged to function responsive to identification of a user which is in fact different from the user that led to the menu 24 being displayed in the first place.

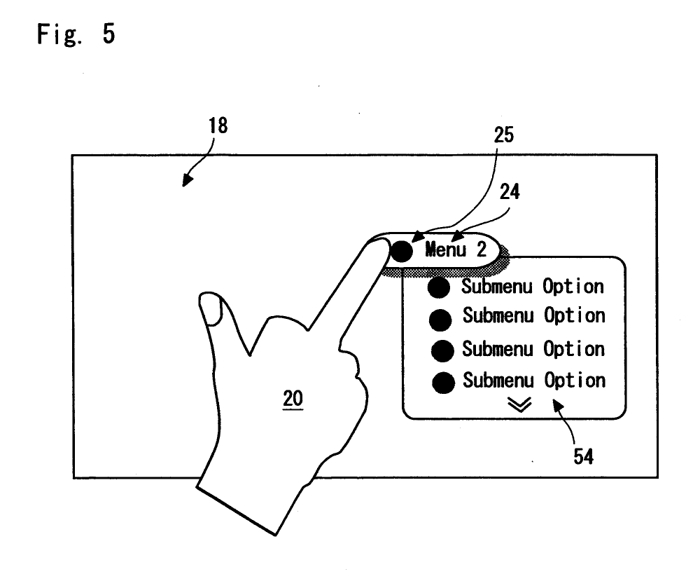

Turning to FIG. 5 there is illustrated the appearance of some menu options 54 in accordance with the user's interaction with the trigger point 25 of the initial menu 24.

Again, the options within the sub menu 54 are determined in accordance with the identification of the particular finger of the right hand 20 activating the trigger point 25.

The regions within the image fields serving as the trigger points can include various characteristics. For example, such trigger points can include an identifiable area of the screen that will have the ability to uniquely read and identify a particular contact, such as a particular-end user's finger such that, as noted, the menu could in fact be opened by one end user, and a second end-user might then be required to invoke a particular unique action by way of interaction with the trigger point. Of course, different recognisable contacts on the trigger point can be employed to invoke different actions and the image area can readily be navigated by a finger without invoking any particular action with the user's finger avoiding the trigger point. Of course, more than one trigger point can be provided within each image field, such as for example the sub menu box 54 of FIG. 5, and again, with trigger point and finger contact offering a wide combination of possible responses.

Insofar as the trigger point could potentially invoke any action, for example the activation of the sub menu as shown in FIG. 5, it should be appreciated that the trigger point is capable of distinguishing between different fingers such that the action invoked by different fingers will create different trigger actions and such features can prove particularly advantageous for the controlled interaction of electronic devices.

In particular, the ability to invoke a specific action for a specific user at a specific point on a user interface can exhibit further advantages particularly when the touch screen includes an interface for a complex control system requiring multiple access by, for example, the crew of a large ship. Appropriate levels of security can then be readily provided and reliably controlled for a large number of users within a multi-user environment.

Remaining with the example of a large ship, the electronic control system can be preset such that if the captain interacts with a touch screen anywhere on the ship, as soon as the finger contact is made, the system can recognise that it is the captain making contact such that the appropriate security level of user settings and privileges can be readily available or accessed by way of the touch screen. However, should, for example, the ships cook then use the same, or indeed different terminal and even if such access might occur immediately after access by the captain, the ship's cook will be immediately identified as the user engaging the touch screen and the users settings and privileges will be varied accordingly.

Thus, while the captain continues to engage with the screen through the appropriate control scenarios, the screen continues to identify that it is truly the captain that remains in contact with the screen insofar as the manner and point of contact that is causing the required control input, also forms an essential part of the user-verification mechanism of the present embodiment.

While a particular end-user is interacting with the touch screen user interface, the end user's interactivity will generally be seen as concurrent so as to allow the user to conduct multiple activities by the user interface in a far simpler way and, for example, typing on a “QWERTY” keyboard with both hands. Such concurrent multi-contact activity can form an important feature of the present embodiment and the ability to recognise individual touch screen contacts.

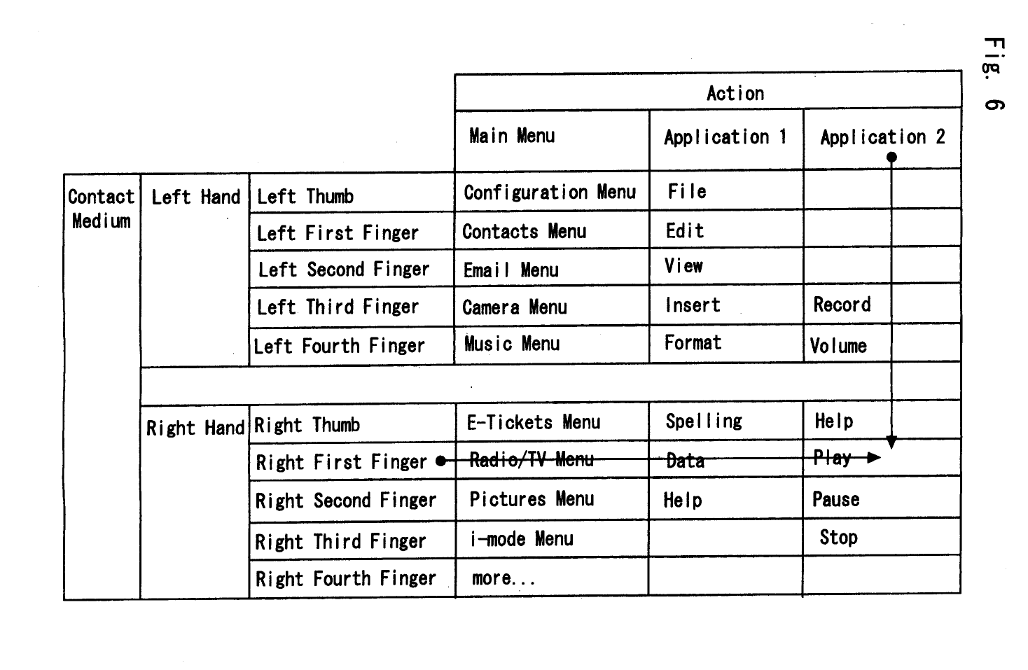

Turning now to FIG. 6, the multi-contact scenarios described herein can be achieved using a mapping table as shown in the table in FIG. 6.

The “Main Menu”, “Application1” and “Application2” represent the “environments”. The hand appendages, the end-user's fingers and thumbs represent the “contact medium”. The combination of the environments and contact medium define a unique action as shown by the arrows in FIG. 6.

If the contact medium included again fingers and thumbs, but from a non-identified end-user, obviously until the electronic device is configured for that user the mapping table would not be appropriate.

In such a scenario, it is assumed there are ten menus each identified by a unique number, ie. Menu 1, Menu 2, . . . , Menu 10. Also the un-identified end-user has ten digits composed of a full set of fingers and thumbs. As they begin make contact with the touch screen with each digit, a menu is assigned to each digit. i.e. Finger 1 is assigned Menu 1, Finger 2 is assigned Menu 2 and so on. In this way the electronic device can now work for both identified and non-identified end-users, if it is permitted to do so.

It should be noted that an end-user's user fingers and thumbs, are not the only possible contact media. For example different identifiable styluses could be used, different hands from different individuals could be used and identified, a glove with identifiable markers could be used, etc and if required employing electronic identifiers and tags. In order for this to work all the device requires is to be able to recognise a type of contact medium and map an action to it, else it treats it as an un-identified contact.

Different contact mediums may require different types of sensors in order to be able to measure its unique qualities in order to subsequently identify it.

For example, if “styluses” with different RFID tags embedded into the tip of the stylus are used, the individual stylus could be identified through use an RFID sensor/reader. Also, the RFID sensor could be combined with a pressure sensor to measure the pressure and location of the stylus. Each stylus could have different properties and actions, for example colour if the environment was an art package.

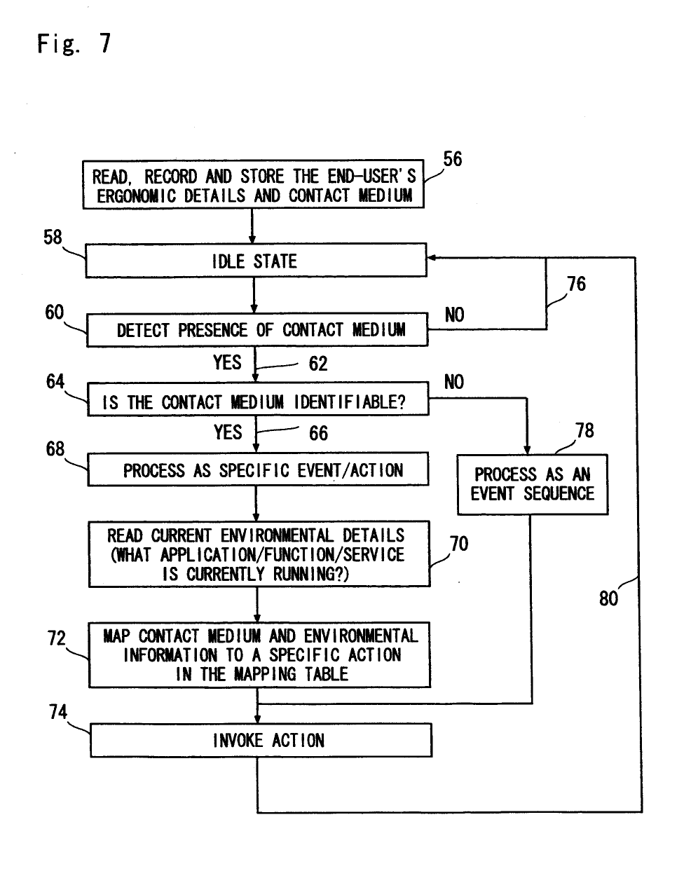

Turning now to FIG. 7 there is provided a flow chart illustrating possible operation of a touch screen and according to an embodiment of a touch screen of the embodiment and when forming part of an electronic device.

Starting at step 56 the device is first arranged to read, record and store an end user's “details” and contact medium such as, for example, a directory of fingerprint details of each of their fingers and thumbs.

With the device in an idle state at 58, it subsequently detects at step 60 the presence of a point of contact of the users contact medium, i.e. one of their fingers or thumbs, and having determined such detection proceeds via 62 to determine at 64 if the details of the point of contact are identifiable.

If, at step 64 it is determined that they are identifiable, the process continues via 66 to process the relevant data at 68 as a specific event action and on the basis of the determination at step 70 as to the nature of any currently running application/function/service.

The particular environmental details of any such application/function/service is then mapped to the identified details of the contact medium at step 72 so as to invoke the appropriate responsive action at 74.

If, at step 60 no presence of a contact medium such as a user's finger was detected, the control of the process returns via 76 to the idle state 58.

If, at step 64 it is determined that the contact medium such as a users finger can not be identified then the process continues to step 78 so as to prove that the control request from the user as an event sequence rather than has been based on any particular predetermined environmental details. At step 78, an option of future possible control functions can then be presented as a required sequence which can be selected as required so as to achieve an appropriate responsive action at step 74.

Once step 74 has been completed and the appropriate action has been invoked, the process returns via loop 80 to its initial idle state 58.

As will be appreciated from the above descriptions, the present embodiment can allow for a touch screen interface advantageously having the ability to measure, record and recognise the individual touch screen contacts and wherein each individually recognisable contact can be used to invoke a specific response/action as required. Yet further, specific touch screen areas identified described hereinbefore as “trigger points” can be further presented and employed so as to enable further recognisable actions and concurrent multi-contact activity can be readily supported. It is envisaged that the embodiment would provide for ready use with hand held touch screen devices, for example, mobile handsets, touch screen monitors, touch screen displays, both large and small, interactive displays using touch sensitive pads, touch screen mobile handsets, electronic books and touch screen user interfaces in general.

It should however be appreciated that the embodiment is no way restricted to features of such embodiments.

So called interactive electronic paper, electronic clothing and interactive objects in general could likewise form appropriate basis for employment of the present embodiment.

It will therefore be appreciated that the device, method and system of the present embodiment are based upon the concept of measuring and recording unique characteristics of a touch screen contact medium by way of embedded sensors so that any subsequent contact by that medium will be electronically recognised in order to invoke a specific response, functionality and/or action. The embodiment advantageously allows for the use of a touch screen device combined with sensors of an appropriate resolution to measure and distinguish between an operator's individual fingers and thumbs and the prior storage of such biometric data can readily be achieved by way of a touch screen electronic device.

Further, the storage of an electronically identifiable contact medium via a single or combination or sensors or touch screen device can be provided and it should be appreciated that the contact medium could be potentially be biological, mineral or indeed chemical and, generally, the touch screen only requires that appropriate sensor technology is implemented and that allows a unique identifying feature.

Of course, the identification of the identifying characteristic can serve to invoke any appropriate response or action which is not merely limited to the change of the graphics and rendering on a user interface, but can relate to any aspect of control and functionality of an electronic device/apparatus/system with which the screen interfaces and the characteristics of which can be displayed upon the screen.

One exemplary aspect of the present embodiment would be summarized as follows: the present embodiment provides for a touch screen readily allowing for multi user access and quick and efficient user access by way of a single user in which, in addition to identifying when touched by a screen engagement member of a user, such as a users finger or thumb, the screen is also arranged to identify an identifying characteristic of such member, such as a users finger or thumb print, so as to differentiate between different users and to allow for subsequent control of at least one aspect of the operation of the screen, and thereby any device/apparatus/system interfacing thereto, responsive to the identification of the said member.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INCORPORATION BY REFERENCE

This application is based upon and claims the benefit of priority from United Kingdom patent application No. 0908456.7, filed on 18 May, 2009, the disclosure of which is incorporated herein in its entirety by reference.

### INDUSTRIAL APPLICABILITY

The present invention is applicable to, for example, a touch screen, related method of operation and system.

### REFERENCE SIGNS LIST

10 user's finger

12 screen surface

12A contact portion

14 under surface of a user's finger

16 a series of capacitive sensors

18 touch screen

20 user's right hand

22 menu

24 menu

25 trigger point

26 menu

28 menu

30 user's hand

32 user's hand

34 menu

36 menu

38 menu

40 menu

42 menu

44 menu

46 menu

48 menu

50 menu

52 menu

54 menu options

1. A touch screen arranged to determine when touched by a user's screen-engagement member and further arranged to identify an identifying characteristic of the said engagement member and so as to differentiate between different screen-engagement members and wherein at least one aspect of subsequent operation of the screen is responsive to the identification of the said member.

2. A touch screen as claimed in claim 1, and comprising an interface device for any one or more of a hand held device, portable device, remote device or system.

3. A touch screen as claimed in claim 1, and arranged for use in a multi-user environment comprising a multi-user device/apparatus/system.

4. A touch screen as claimed in claim 1, and arranged for engagement with the user's screen-engagement member in the form of a user's finger and/or thumb.

5. A touch screen as claimed in claim 4 wherein the said identifying characteristic of the said screen engagement member comprises biometric data.

6. A touch screen as claimed in claim 5 wherein the identifying characteristic comprises a user's finger/thumb print.

7. A touch screen as claimed in claim 1 wherein the screen-engagement member comprises a screen contact device including a unit that serves to provide said identifying characteristic.

8. A touch screen as claimed in claim 7, wherein the said unit that serves to provide said identifying characteristic comprises an electronic device.

9. A touch screen as claimed in claim 8, wherein the electronic device comprises an electronic tag.

10. A touch screen as claimed in claim 7, wherein the screen-engagement member comprises a screen-engagement stylus.

11. A touch screen as claimed in claim 1, wherein the said identifying characteristic serves to identify the screen-engagement member.

12. A touch screen as claimed in claim 1, wherein the said identifying characteristic serves to identify the screen-user.

13. A touch screen as claimed in claim 1, wherein the at least one aspect of subsequent operation comprises display options of the screen and the provision of a predetermined image field.

14. A touch screen as claimed in claim 13, wherein the said predetermined image field includes at least one region for identifying an identifying characteristic of the screen-engagement member for differentiating between different screen-engagement members.

15. A touch screen as claimed in claim 14 wherein the said at least one region comprises at least one trigger point for initiating a further response of the touch screen.

16. A touch screen as claimed in claim 14 in which the said image field and the said at least one region exhibit a menu-tree structure.

17. A touch screen as claimed in claim 1, wherein the said at least one aspect of subsequent operation can include functional options and/or functional control options of the screen or device/apparatus/system interfacing thereto.

18. A touch screen as claimed in claim 1, wherein the said at least one aspect includes user access to the screen and/or to a device/apparatus/system interfacing thereto.

19. A touch screen as defined in claim 18 wherein the at least one aspect of subsequent operation relates to user settings and/or privileges within the screen and/or a device/apparatus/system interfacing thereto.

20. A touch screen as claimed in claim 1 and further arranged to capture identifying characteristics of one or more screen-engagement members for subsequent use in determining the said operation.

21. A multi-user electronic control system including at least one touch screen as defined in claim 1.

22. A method of controlling at least one aspect of operation of a touch screen including determining when touched by a user's screen engagement member and including the steps of identifying an identifying characteristic of the said screen engagement member so as to differentiate between different screen engagement members, and wherein the said at least one aspect is controlled responsive to identification of the said screen engagement member.
